(19) United States
(12) Patent Application Publication
(10) Pub. No.: US 2014/0045508 A1
(43) Pub. Date: Feb. 13, 2014

(54) CODE RATE ADAPTATION IN WIRELESS COMMUNICATION SYSTEMS

(71) Applicants: Chandra Sekhar Bontu, Nepean (CA); Yi Song, Plano, TX (US); Zhijun Cai, Euless, TX (US)

(72) Inventors: Chandra Sekhar Bontu, Nepean (CA); Yi Song, Plano, TX (US); Zhijun Cai, Euless, TX (US)

(21) Appl. No.: 13/569,082

(22) Filed: Aug. 7, 2012

(51) Int. Cl. H04W 4/00; H04W 72/04

(52) U.S. Cl. 455/450; 455/422.1

(57) ABSTRACT

Systems, methods, and apparatuses for transmitting physical hybrid automatic repetition request indicator channel (PHICH) signals using adaptive code rates are provided. In accordance with one implementation, various PHICH code rates may be supported by configuring a different number of resource element groups (REGs) to transmit the PHICH signal. The information regarding the REGs may be transmitted to a user equipment (UE) in a radio resource control (RRC) message or in an uplink grant message or in a medium access control (MAC) control element. Correspondingly, the UE may detect the PHICH signal with adaptive code rate on the indicated REGs. Furthermore, channel state information (CSI) may be transmitted from the UE to a base station to indicate the measured PHICH quality, such that the base station may determine appropriate PHICH code rate for the UE based on the CSI information.

### TECHNICAL FIELD

The present disclosure generally relates to transmission of Hybrid Automatic Repetition Request (HARQ) indicators in wireless communication systems, and more particularly, to transmission of HARQ indicators using adaptive code rates.

### BACKGROUND

In wireless radio access networks such as Long Term Evolution (LTE) and LTE-Advanced communication networks, HARQ indicators may be transmitted to notify a packet sending entity whether a transmitted packet was successfully received. For example, a base station may transmit Physical HARQ Indicator Channel (PHICH) signals in response to a received uplink packet from a User Equipment (UE). Upon receiving a PHICH signal, the UE may retransmit the uplink packet if the received PHICH signal indicates an unsuccessful reception of the uplink packet at the base station.

The PHICH signal may be coded before transmission to increase the probability of successful reception at the UE. In other words, the base station may add some redundancy to the PHICH signal, or code the PHICH signal before transmitting the coded PHICH signal to the UE. Moreover, to improve the spectral efficiency, PHICH signals for multiple UEs may be multiplexed at the same time and frequency resources using orthogonal code sequences.

### BRIEF DESCRIPTION OF THE DRAWINGS

The accompanying drawings, which are incorporated in and constitute part of this specification, and together with the description, illustrate and serve to explain various embodiments.

FIG. 1 illustrates an example cellular wireless communication system for implementing methods and systems consistent with the present disclosure.

FIG. 2 illustrates an example access node device, in accordance with an embodiment of the present disclosure.

FIG. 3 illustrates an example user equipment device, in accordance with an embodiment of the present disclosure.

FIG. 4 illustrates an example LTE downlink physical resource structure for implementing methods and systems consistent with the present disclosure.

FIG. 5 illustrates an example resource mapping scheme for PHICH signals, in accordance with an embodiment of the present disclosure.

FIG. 6 illustrates a flow diagram of an example method for enabling code rate adaptation of PHICH signals, in accordance with an embodiment of the present disclosure.

FIG. 7 illustrates a flow diagram of another example method for enabling code rate adaptation of PHICH signals, in accordance with an embodiment of the present disclosure.

FIG. 8 illustrates a flow diagram of an example method for uplink resource grant procedure, in accordance with an embodiment of the present disclosure.

FIG. 9 illustrates a flow diagram of an example method for receiving PHICH signals with code rate adaptation performed by a user equipment, in accordance with an embodiment of the present disclosure.

### DETAILED DESCRIPTION

The present disclosure is directed to systems, methods, and apparatuses for transmitting and receiving PHICH signals with adaptive code rates. PHICH signals are used to notify UE whether an uplink packet is received at a base station. With an increased number of users and applications that utilize data packets, improving PHICH capacity in wireless networks helps to accommodate the increased PHICH traffic. Meanwhile, although the PHICH capacity may be improved by allocating more resources to the PHICH signals, this would require additional time or frequency resources for the PHICH signals, and may introduce additional cost to the wireless system. In the present disclosure, methods for improving the PHICH capacity are provided by taking advantage of different channel conditions and employing an adaptive code rate for the transmission of PHICH signals.

To improve the PHICH capacity, in some implementations consistent with this disclosure, PHICH signals may be transmitted using different code rates depending on PHICH channel conditions at the UE. For example, a higher code rate, and correspondingly, fewer resource element groups (REGs) may be used to transmit the PHICH signals for UEs having a high signal to noise plus interference ratio (SINR), i.e., better channel conditions. When a UE is located near a cell coverage center of a base station i.e., cell center, the SINR is normally higher than when the UE is located near a cell coverage edge of the base station, i.e., cell edge. Conversely, a lower code rate, and correspondingly, more resource element groups may be used to transmit the

PHICH signals for UEs having a low SINR, i.e., worse channel conditions. In this way, the PHICH resources are efficiently utilized according to specific channel conditions of the UEs. To enable the rate adaptation of the PHICH signals, the UE may report its channel state information (CSI) with respect to its received PHICH signals to a base station. Subsequently, the base station may determine appropriate code rate and number of REGs used for the PHICH signal and transmit the information regarding the number of REGs used for the PHICH signal in a radio resource control (RRC) message or in an uplink grant message or in a medium access control (MAC) control element to the UE. Accordingly, the UE may detect and decode the received PHICH signals based on the information regarding the REGs used for the PHICH signal. As such, PHICH signals with adaptive code rate may be enabled in the wireless network to enhance the PHICH capacity.

Reference will now be made in detail to the example embodiments implemented according to the disclosure; the examples are illustrated in the accompanying drawings. Wherever possible, the same reference numbers will be used throughout the drawings to refer to the same or like parts.

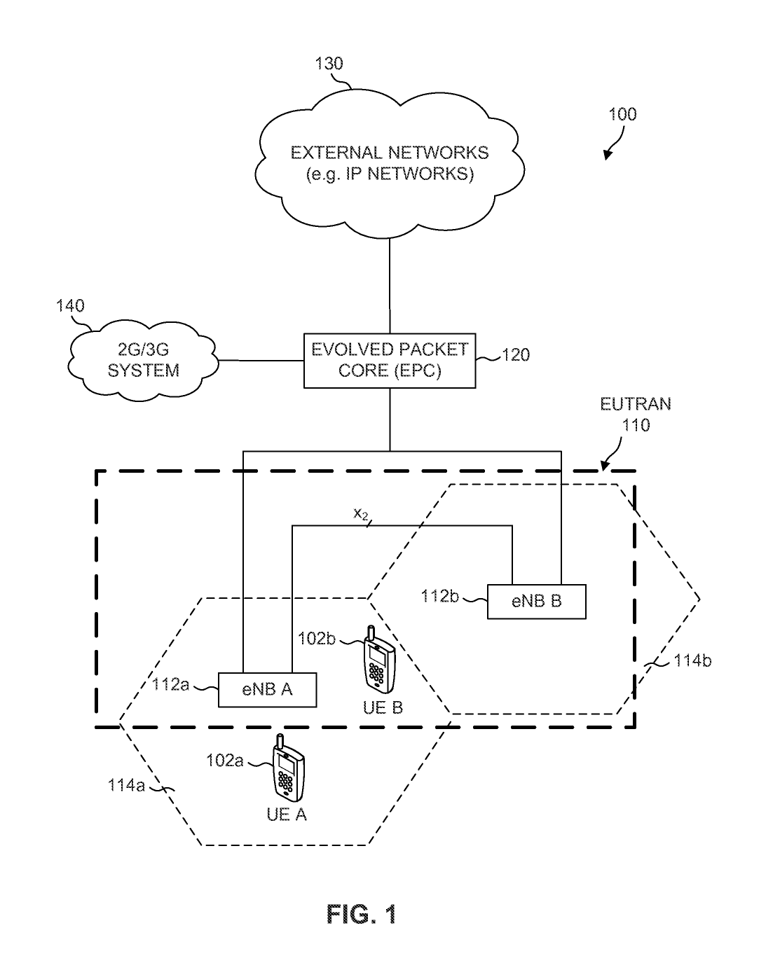

FIG. 1 illustrates an example cellular wireless communication system 100 in which systems and methods consistent with this disclosure may be implemented. The cellular network system 100 shown in FIG. 1 includes one or more base stations (i.e., 112a and 112b). In the LTE example of FIG. 1, the base stations are shown as evolved Node Bs (eNBs) 112a and 112b, although base stations operate in any wireless communications system, including for example, macro cell, femto cell, and pico cell. Base stations are nodes that can relay signals for mobile devices, also referred to herein a user equipment, or other base stations. The base stations are also referred to as access node devices. The example LTE telecommunications environment 100 of FIG. 1 includes one or more radio access networks 110, core networks (CNs) 120, and external networks 130. In certain implementations, the radio access networks may be Evolved Universal Terrestrial Radio Access Networks (EUTRANs). In addition, core networks 120 may be evolved packet cores (EPCs). Further, as shown one or more mobile electronic devices 102a, 102b operate within the LTE system 100. In some implementations, 2G/3G systems 140, e.g., Global System for Mobile communication (GSM), Interim Standard 95 (IS-95), Universal Mobile Telecommunications System (UMTS) and Code Division Multiple Access (CDMA2000) may also be integrated into the LTE telecommunication system 100.

In the example LTE system shown in FIG. 1, the EUTRAN 110 includes eNB 112a and eNB 112b. Cell 114a is the service area of eNB 112a and Cell 114b is the service area of eNB 112b. User equipment (UEs) 102a and 102b operate in Cell 114a and are served by eNB 112a. The EUTRAN 110 can include one or more eNBs (i.e., eNB 112a and eNB 112b) and one or more UEs (i.e., UE 102a and UE 102b) can operate in a cell. The eNBs 112a and 112b communicate directly to the UEs 102a and 102b. In some implementations, the eNB 112a or 112b may be in a one-to-many relationship with the UEs 102a and 102b, e.g., eNB 112a in the example LTE system 100 can serve multiple UEs (i.e., UE 102a and UE 102b) within its coverage area Cell 114a, but each of UE 102a and UE 102b may be connected to one eNB 112a at a time. In some implementations, the eNBs 112a and 112b may be in a many-to-many relationship with the UEs, e.g., UE 102a and UE 102b can be connected to eNB 112a and eNB 112b. The eNB 112a may be connected to eNB 112b in which handover may be conducted if one or both of the UEs 102a and UE 102b travels from cell 114a to cell 114b. The UEs 102a and 102b may be any wireless electronic device used by an end-user to communicate, for example, within the LTE system 100.

The UEs 102a and 102b may transmit voice, video, multimedia, text, web content and/or any other user/client-specific content. The transmission of some contents, e.g., video and web content, may require high channel throughput to satisfy the end-user demand. In some instances, however, the channel between UEs 102a, 102b and eNBs 112a, 112b may be contaminated by multipath fading due to the multiple signal paths arising from many reflections in the wireless environment. Accordingly, the UEs' transmission may adapt to the wireless environment. In short, the UEs 102a and 102b generate requests, send responses or otherwise communicate in different means with Evolved Packet Core (EPC) 120 and/or Internet Protocol (IP) networks 130 through one or more eNBs 112a and 112b.

Examples of UE include, but are not limited to, a mobile phone, a smart phone, a telephone, a television, a remote controller, a set-top box, a computer monitor, a computer (including a tablet computer such as a BlackBerry® Playbook tablet, a desktop computer, a handheld or laptop computer, a netbook computer), a personal digital assistant (PDA), a microwave, a refrigerator, a stereo system, a cassette recorder or player, a DVD player or recorder, a CD player or recorder, a VCR, an MP3 player, a radio, a camcorder, a camera, a digital camera, a portable memory chip, a washer, a dryer, a washer/dryer, a copier, a facsimile machine, a scanner, a multi-functional peripheral device, a wristwatch, a clock, and a game device, etc. The UE 102a or 102b may include a device and a removable memory module, such as a Universal Integrated Circuit Card (UICC) that includes a Subscriber Identity Module (SIM) application, a Universal Subscriber Identity Module (USIM) application, or a Removable User Identity Module (R-UIM) application. Alternatively, the UE 102a or 102b may include the device without such a module. The term “UE” can also refer to any hardware or software component that can terminate a communication session for a user. In addition, the terms “user equipment,” “UE,” “user equipment device,” “user agent,” “UA,” “user device,” and “mobile device” can be used synonymously herein.

A radio access network is part of a mobile telecommunication system which implements a radio access technology, such as Universal Mobile Telecommunications System (UMTS), CDMA2000 and 3rd Generation Partnership Project (3GPP) LTE. In many applications, the Radio Access Network (RAN) included in an LTE telecommunications system 100 is called an EUTRAN 110. The EUTRAN 110 can be located between the UEs 102a, 102b and EPC 120. The EUTRAN 110 includes at least one eNB 112a or 112b. The eNB can be a radio base station that may control all, or at least some, radio related functions in a fixed part of the system. One or more of eNB 112a or 112b can provide radio interface within their coverage area or a cell for the UEs 102a, 102b to communicate. The eNBs 112a and 112b may be distributed throughout the cellular network to provide a wide area of coverage. The eNBs 112a and 112b directly communicate with one or more UEs 102a, 102b, other eNBs, and the EPC 120.

In the EUTRAN, the UEs 102 may transmit an uplink packet to the eNB 112 and receive a HARQ indicator (HI) for the transmitted packet. The HI indicates whether the uplink packet is correctly received at the eNB 112. For example, an ACK indicates that the uplink packet is successfully received while a NACK indicates that the uplink packet is not successfully received. The HI may be coded and transmitted in the form of PHICH signals. In some implementations consistent with the present disclosure, the PHICH signals may be transmitted using adaptive code rates based on the PHICH channel condition between the UE 102 and the eNB 112. In addition, the UEs 102 may also transmit CSI to report the PHICH channel condition to the eNBs 112 such that appropriate code rate and number of REGs may be selected by the eNBs for the transmission of PHICH signals.

The eNBs 112a and 112b may be the end point of the radio protocols towards the UEs 102a, 102b and may relay signals between the radio connection and the connectivity towards the EPC 120. In certain implementations, the EPC 120 is the main component of a core network (CN). The CN can be a backbone network, which may be a central part of the telecommunications system. The EPC 120 can include a mobility management entity (MME), a serving gateway (SGW), and a packet data network gateway (PGW). The MME may be the main control element in the EPC 120 responsible for the functionalities comprising the control plane functions related to subscriber and session management. The SGW can serve as a local mobility anchor, such that the packets are routed through this point for intra EUTRAN 110 mobility and mobility with other legacy 2G/3G systems 140. The SGW functions may include the user plane tunnel management and switching. The PGW may provide connectivity to the services domain comprising external networks 130, such as the IP networks. The UEs 102a, 102b, EUTRAN 110, and EPC 120 are sometimes referred to as the evolved packet system (EPS). It is to be understood that the architectural evolvement of the LTE system 100 is focused on the EPS. The functional evolution may include both EPS and external networks 130.

Though described in terms of FIG. 1, the present disclosure is not limited to such an environment. In general, cellular telecommunication systems may be described as cellular networks made up of a number of radio cells, or cells that are each served by a base station or other fixed transceiver. The cells are used to cover different areas in order to provide radio coverage over an area. Example cellular telecommunication systems include Global System for Mobile Communication (GSM) protocols, Universal Mobile Telecommunications System (UMTS), 3GPP Long Term Evolution (LTE), and others. In addition to cellular telecommunication systems, wireless broadband communication systems may also be suitable for the various implementations described in the present disclosure. Example wireless broadband communication systems include IEEE 802.11 WLAN, IEEE 802.16 WiMAX network, etc.

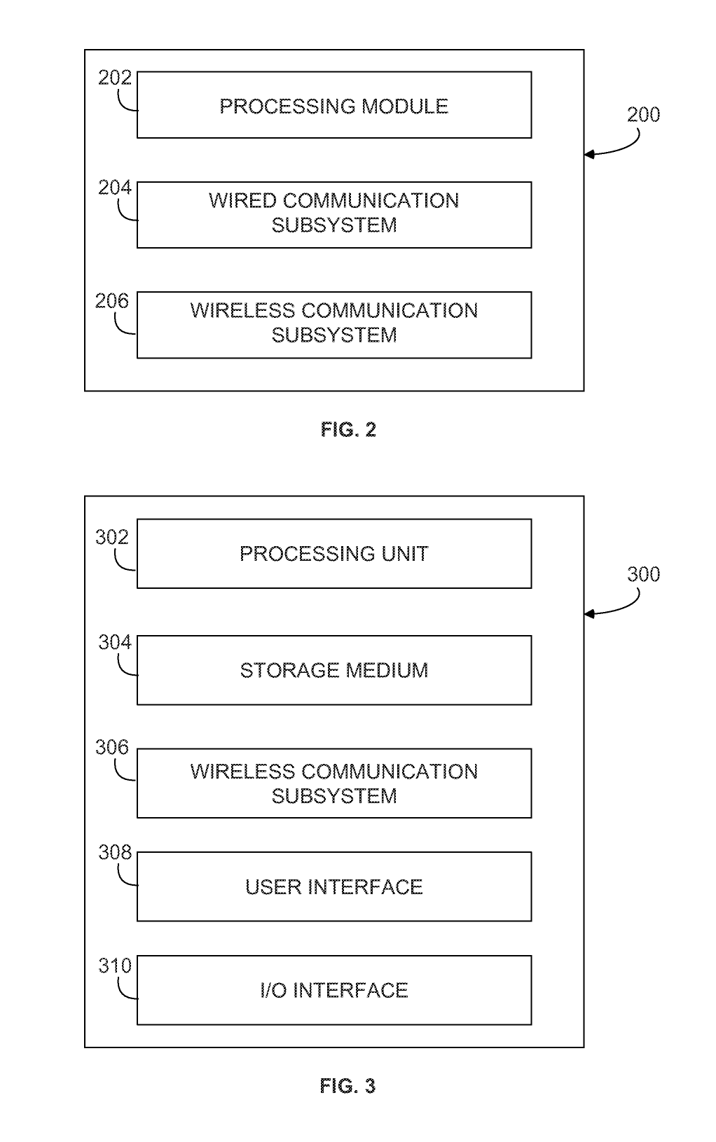

FIG. 2 illustrates an example access node device 200 consistent with certain aspects of this disclosure. The example access node device 200 includes a processing module 202, a wired communication subsystem 204, and a wireless communication subsystem 206. The processing module 202 can include one or more processing components (alternatively referred to as “processors” or “central processing units” (CPUs)) operable to execute instructions associated with managing IDC interference. The processing module 202 can also include other auxiliary components, such as random access memory (RAM), read only memory (ROM), secondary storage (for example, a hard disk drive or flash memory). For example, the processing module 202 may be configured to transmit PHICH signals using adaptive code rate. The processing module 202 may also be configured to determine the resource element groups for the transmission of PHICH signals. In some implementations, the processing module 202 may be configured to determine code rate for the transmission of PHICH signals based on the CSI received from the UEs. Furthermore, the processing module 202 may be configured to multiplex PHICH signals for multiple UEs at the same REGs with different orthogonal code sequences. Additionally, the processing module 202 can execute certain instructions and commands to provide wireless or wired communication, using the wired communication subsystem 204 or a wireless communication subsystem 206. One skilled in the art will readily appreciate that various other components can also be included in the example access node device 200.

FIG. 3 illustrates an example user equipment device 300. The example user equipment device 300 includes a processing unit 302, a computer readable storage medium 304 (for example, ROM or flash memory), a wireless communication subsystem 306, a user interface 308, and an I/O interface 310.

The processing unit 302 may include components and perform functionalities similar to the processing module 202 described with regard to FIG. 2. Moreover, the processing unit 302 may be configured to receive the PHICH signals with adaptive code rate. The processing unit 302 may further be configured to determine the REGs at which PHICH signals are transmitted. In some implementations, the processing unit 302 may be configured to receive information regarding the REGs at which the PHICH signals are transmitted, in a radio resource control (RRC) message or in an uplink grant message or in a MAC control element.

The wireless communication subsystem 306 may be configured to provide wireless communications for data information or control information provided by the processing unit 302. The wireless communication subsystem 306 can include, for example, one or more antennas, a receiver, a transmitter, a local oscillator, a mixer, and a digital signal processing (DSP) unit. In some implementations, the wireless communication subsystem 306 can support MIMO transmissions.

The user interface 308 can include, for example, one or more of a screen or touch screen (for example, a liquid crystal display (LCD), a light emitting display (LED), an organic light emitting display (OLED), a microelectromechanical system (MEMS) display, a keyboard or keypad, a tracking device (e.g., trackball, trackpad), a speaker, and a microphone. The I/O interface 310 can include, for example, a universal serial bus (USB) interface. One skilled in the art will readily appreciate that various other components can also be included in the example UE device 300.

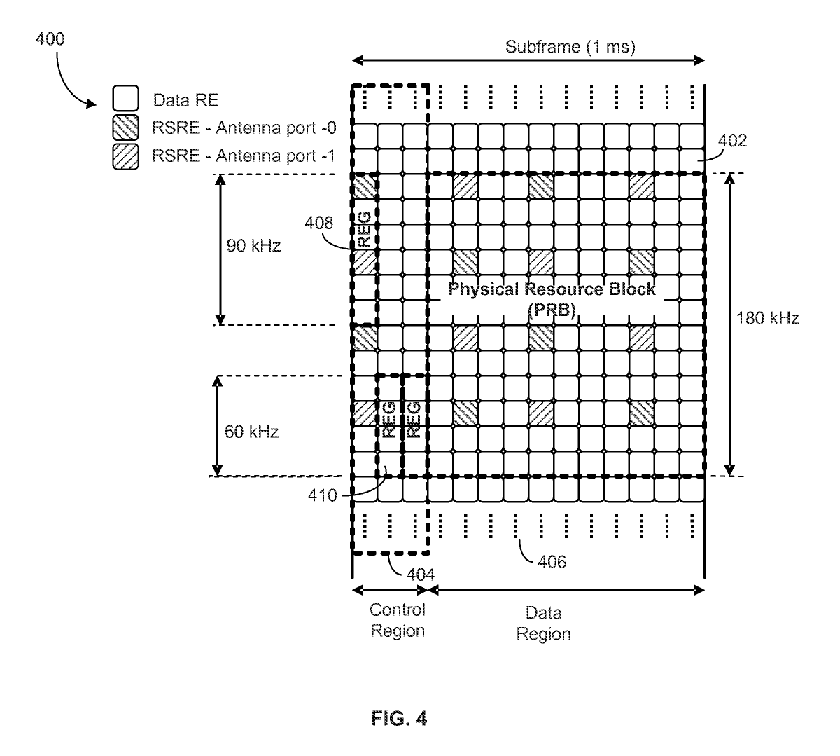

FIG. 4 illustrates an example LTE downlink physical resource structure for implementing methods and systems consistent with the present disclosure. The LTE downlink adopts orthogonal frequency division multiplexing (OFDM) technology. An OFDM subframe consists of a number of OFDM symbols, each occupying a certain time duration. As shown in FIG. 4, each grid (e.g., 402) is a basic unit of time and frequency resource which is called a resource element (RE). The resource elements used for reference signals are referred to as reference signal resource elements (RSREs). Other REs that are not for reference signal (RS) transmission are used for data transmission and are referred to as data REs. The control region of a subframe contains time-frequency resources in the first few OFDM symbols (1-4 symbols) 404 within a subframe, which are allocated to layer 1 control signaling. The time-frequency resources in the rest of the OFDM symbols 406 are allocated to data transmission and are referred to as data region of a subframe. The frequency resources in each OFDM symbol in the control region are allocated for layer 1 control signaling transmission in groups of 4 or 6 REs, termed as resource element groups, such as 408 and 410. Each resource element group (REG) consists of 4 data REs. Among these REGs, 4 REGs within the first OFDM symbol are assigned to transmit physical control format indicator channel (PCFICH). The rest of the REGs are assigned to transmit PHICH and physical downlink control channel (PDCCH).

PHICH signals for multiple UEs may be mapped to the same REGs but with different orthogonal code sequences. For example, a PHICH resource may be identified by the index pair (n_{PHICH}^{group}, n_{PHICH}^{seq}), where n_{PHICH}^{group} is the PHICH group number and n_{PHICH}^{seq} is the orthogonal sequence index within the group. Furthermore, linear block code, e.g., repetition code may be applied to the HI prior to the application of orthogonal code sequences. An example repetition code for the PHICH signal is illustrated in Table 1. The HI is coded according to following Table, where for a positive acknowledgement HI=1 and for a negative acknowledgement HI=0.

TABLE 1
HI code words

| | HI code word |
|---|---|
| HI | {b₀, b₁, b₂} |
| 0 | <0, 0, 0> |
| 1 | <1, 1, 1> |

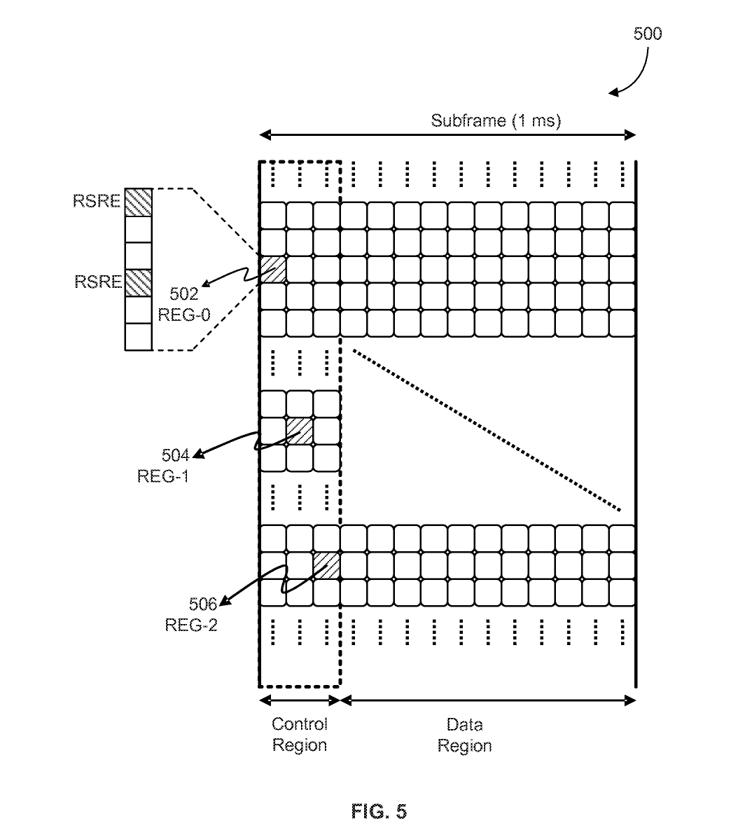

FIG. 5 illustrates an example resource mapping scheme for PHICH signals. In this example, the PHICH signal is mapped to 3 REGs, i.e., 502, 504, and 506, spread across the available channel bandwidth. Each REG contains 4 data REs and the first REG 502 additionally contains 2 RSREs. As shown in FIG. 5, the REGs used to transmit the PHICH signal may be located at different OFDM symbols and frequencies for better frequency or time diversity. Although the three REGs shown in FIG. 5 are located at different OFDM symbols, it is also possible that the REGs are located at different frequencies of the same OFDM symbol. In some implementations, the number of REGs may be flexible, enabling variable code rate of the PHICH signal depending on various conditions, for example, downlink signal reception quality. For example, if a UE 102a is very close to the eNB 112a, or the UE 102a is equipped with more than one receive antennas, or the UE 102a is equipped with an advanced receiver, the downlink signal reception quality at the UE may be very good. In this case, only one REG out of the three available REGs suffice for a successful PHICH reception at the UE. The reduced number of REGs would require that a higher code rate is employed for the PHICH signal. On the other hand, if the UE 102a is located far from the eNB 112a and the downlink signal reception quality at the UE may be poor, increased number of REGs (e.g., 4 REGs) may be used for the transmission of PHICH signal. The increased number of REGs would allow a lower code rate to be applied to the PHICH signal, reducing the error probability of decoding the PHICH signals.

In the case that a repetition code is used for the coding of PHICH signals, the code rate may be adjusted by controlling the repetition factor applied on the HI bit. As an example, lower repetition factor and reduced number of REGs may be used for UEs located at cell center which may have better SINR, and higher repetition factor and increase number of REGs may be used for UEs located at cell edge which may have worse SINR, to adaptively control the code rate of the PHICH signals.

A dedicated radio resource control (RRC) message (e.g., RRCConnectionReconfiguration) can be sent to the UE to specify the REGs over which the PHICH will be sent, such that the UE can decode the PHICH correctly. Table 2 shows an example RRCConnectionReconfiguration information element required to enable this type of rate adaption for PHICH. The description of the fields included in the Radio Resource Configuration information element is provided in Table 3. Note that other RRC messages could also be used for this purpose.

Specifically, a PHICH_REG_MAP field may be used to indicate the information of REGs for the transmission of PHICH signal. In some implementations, the REG information may be represented by one or more bit maps in the PHICH_REG_MAP field. For example, if the first REG is selected for PHICH transmission to a first UE and other two REGs are selected for PHICH transmission for a second UE, the PHICH_REG_MAP may be set to ‘100’ and ‘011’ in the RRCConnectionReconfiguration message to the first and second UEs, respectively. When the channel condition for a UE is observed to change significantly, a RRCConnectionReconfiguration message can be sent to the UE to indicate the REG location map for the future PHICH signals.

TABLE 2
RadioResourceConfigDedicated information element

| | | | |
|---|---|---|---|
| -- ASN1START | | | |
| RadioResourceConfigDedicated ::= | SEQUENCE { | | |
| srb-ToAddModList | SRB-ToAddModList | OPTIONAL, | -- |
| Cond HO-Conn | | | |
| drb-ToAddModList | DRB-ToAddModList | OPTIONAL, | -- |
| Cond HO-toEUTRA | | | |
| drb-ToReleaseList | DRB-ToReleaseList | OPTIONAL, | -- |
| Need ON | | | |
| mac-MainConfig | CHOICE { | | |

| | | |
|---|---|---|
| explicitValue | MAC-MainConfig, | |
| defaultValue | NULL | |
| } OPTIONAL, | | -- |

| | | | |
|---|---|---|---|
| Cond HO-toEUTRA2 | | | |
| sps-Config | SPS-Config | OPTIONAL, | -- |
| Need ON | | | |
| physicalConfigDedicated | PhysicalConfigDedicated | OPTIONAL, | -- |
| Need ON | | | |
| ..., | | | |

| | | | |
|---|---|---|---|
| [[ rlf-TimersAndConstants-r9 | RLF-TimersAndConstants-r9 | OPTIONAL | - |

| | | | |
|---|---|---|---|
| - Need ON | | | |
| ]], | | | |
| [[ measSubframePatternPCell-r10 | MeasSubframePatternPCell-r10 | OPTIONAL | - |
| - Need ON | | | |
| ]] | | | |
| toEUTRA3 | | | |
| PHICH-REG-ConfigDedicated | PHICH-REG-ConfigDedicated | OPTIONAL | |
| } | | | |

| | |
|---|---|
| RadioResourceConfigDedicatedSCell-r10 ::= | SEQUENCE { |

-- UE specific configuration extensions applicable for an SCell

| | | |
|---|---|---|
| physicalConfigDedicatedSCell-r10 | PhysicalConfigDedicatedSCell-r10 | OPTIONAL, |
| ... | | |
| } | | |

| | |
|---|---|
| SRB-ToAddModList ::= | SEQUENCE (SIZE (1..2)) OF SRB-ToAddMod |

| | |
|---|---|
| SRB-ToAddMod ::= SEQUENCE { | |
| srb-Identity | INTEGER (1..2), |
| rlc-Config | CHOICE { |

| | | |
|---|---|---|
| explicitValue | RLC-Config, | |
| defaultValue | NULL | |
| } OPTIONAL, | | -- |
| Cond Setup | | |
| logicalChannelConfig | CHOICE { | |
| explicitValue | LogicalChannelConfig, | |
| defaultValue | NULL | |
| } OPTIONAL, | | -- |
| Cond Setup | | |
| ... | | |
| } | | |

| | |
|---|---|
| DRB-ToAddModList ::= | SEQUENCE (SIZE (1..maxDRB)) OF DRB-ToAddMod |

| | | | |
|---|---|---|---|
| DRB-ToAddMod ::= SEQUENCE { | | | |
| eps-BearerIdentity | INTEGER (0..15) | OPTIONAL, | -- Cond |
| DRB-Setup | | | |
| drb-Identity | DRB-Identity, | | |
| pdcp-Config | PDCP-Config | OPTIONAL, | -- Cond |
| PDCP | | | |
| rlc-Config | RLC-Config | OPTIONAL, | -- Cond |
| Setup | | | |
| logicalChannelIdentity | INTEGER (3..10) | OPTIONAL, | -- Cond |
| DRB-Setup | | | |
| logicalChannelConfig | LogicalChannelConfig | OPTIONAL, | -- Cond |
| Setup | | | |
| ... | | | |
| } | | | |

| | |
|---|---|
| DRB-ToReleaseList ::= | SEQUENCE (SIZE (1..maxDRB)) OF DRB-Identity |

| | |
|---|---|
| MeasSubframePatternPCell-r10 ::= | CHOICE { |
| release | NULL, |

| | |
|---|---|
| setup | MeasSubframePattern-r10 |
| } | |
| PHICH-REG-ConfigDedicated ::= | Sequence |
| PHICH REG MAP | INTEGER(1...7) |
| -- ASN1STOP | |

TABLE 3
RadioResourceConfigDedicated field descriptions

logicalChannelConfig
For SRBs a choice is used to indicate whether the logical channel configuration is signalled explicitly or set to the
default logical channel configuration for SRB1 as specified in 9.2.1.1 or for SRB2 as specified in 9.2.1.2.
logicalChannelIdentity
The logical channel identity for both UL and DL.
mac-MainConfig
Although the ASN.1 includes a choice that is used to indicate whether the mac-MainConfig is signalled explicitly or set
to the default MAC main configuration as specified in 9.2.2, EUTRAN does not apply “defaultValue”.
measSubframePatternPCell
Time domain measurement resource restriction pattern for the PCell measurements (RSRP, RSRQ and the radio link
monitoring).
physicalConfigDedicated
The default dedicated physical configuration is specified in 9.2.4.
rlc-Config
For SRBs a choice is used to indicate whether the RLC configuration is signalled explicitly or set to the values defined
in the default RLC configuration for SRB1 in 9.2.1.1 or for SRB2 in 9.2.1.2. RLC AM is the only applicable RLC mode
for SRB1 and SRB2. E-UTRAN does not reconfigure the RLC mode of DRBs except when a full configuration option is
used, and may reconfigure the UM RLC SN field size only upon handover within E-UTRA or upon the first
reconfiguration after RRC connection re-establishment.
sps-Config
The default SPS configuration is specified in 9.2.3.
srb-Identity
Value 1 is applicable for SRB1 only.
Value 2 is applicable for SRB2 only.
PHICH_REG_MAP
001 to 111; A ‘1’ will indicate presence of PHICH. The position of each bit corresponds to the REG number used for
sending PHICH.

Additional PHICH_REG_MAP fields may be included to enable more REGs to be allocated for the PHICH transmission. For example, more than three REGs may be allocated to cell edge users for the PHICH transmission to improve the PHICH reception performance. In this case the RRCConnectionReconfiguration message may be modified as in Table 4 (although other RRC messages may also be used for this purpose). The description of the corresponding fields included in the Radio Resource Configuration information element is provided in Table 5. As illustrated in Tables 4 and 5, there are more than one PHICH_REG_MAPs, i.e., PHICH_REG_MAP1 and PHICH_REG_MAP2. The PHICH index pair for determining the available resources for PHICH_REG_MAP1 and PHICH_REG_MAP2 may be related and pre-defined, for example, in radio access network standards.

For example, if (g₁, n₁) and (g₂, n₂) are the PHICH index pair corresponding to PHICH_REG_MAP1 and PHICH_REG_MAP2 respectively, then the PHICH index pair corresponding to PHICH_REG_MAP2 can be defined as follows:

g₂=mod(g₁+l, N_{PHICH}^{group})

n₂=mod(n₁+m, 8)

where l and m are defined in the radio access network standards.

TABLE 4
RadioResourceConfigDedicated information element including multiple PHICH_REG_MAPs

| | | | |
|---|---|---|---|
| -- ASN1START | | | |
| RadioResourceConfigDedicated ::= | SEQUENCE { | | |
| srb-ToAddModList | SRB-ToAddModList | OPTIONAL, | -- |
| Cond HO-Conn | | | |
| drb-ToAddModList | DRB-ToAddModList | OPTIONAL, | -- |
| Cond HO-toEUTRA | | | |
| drb-ToReleaseList | DRB-ToReleaseList | OPTIONAL, | -- |
| Need ON | | | |
| mac-MainConfig | CHOICE { | | |
| explicitValue | MAC-MainConfig, | | |
| defaultValue | NULL | | |
| } OPTIONAL, | -- | | |
| Cond HO-toEUTRA2 | | | |
| sps-Config | SPS-Config | OPTIONAL, | -- |
| Need ON | | | |
| physicalConfigDedicated | PhysicalConfigDedicated | OPTIONAL, | -- |
| Need ON | | | |
| ..., | | | |

| | | | |
|---|---|---|---|
| [[ rlf-TimersAndConstants-r9 | RLF-TimersAndConstants-r9 | OPTIONAL | - |
| - Need ON | | | |
| ]], | | | |
| [[ measSubframePatternPCell-r10 | MeasSubframePatternPCell-r10 | OPTIONAL | - |
| - Need ON | | | |
| ]] | | | |
| toEUTRA3 | | | |
| PHICH-REG-ConfigDedicated | PHICH-REG-ConfigDedicated | OPTIONAL | |
| } | | | |

| | |
|---|---|
| RadioResourceConfigDedicatedSCell-r10 ::= | SEQUENCE { |

-- UE specific configuration extensions applicable for an SCell

| | | |
|---|---|---|
| physicalConfigDedicatedSCell-r10 | PhysicalConfigDedicatedSCell-r10 | OPTIONAL, |
| ... | | |
| } | | |

| | |
|---|---|
| SRB-ToAddModList ::= | SEQUENCE (SIZE (1..2)) OF SRB-ToAddMod |
| SRB-ToAddMod ::= SEQUENCE { | |

| | |
|---|---|
| srb-Identity | INTEGER (1..2), |
| rlc-Config | CHOICE { |

| | |
|---|---|
| explicitValue | RLC-Config, |
| defaultValue | NULL |

| | |
|---|---|
| } OPTIONAL, | -- |

| | |
|---|---|
| Cond Setup | |
| logicalChannelConfig | CHOICE { |

| | |
|---|---|
| explicitValue | LogicalChannelConfig, |
| defaultValue | NULL |

| | |
|---|---|
| } OPTIONAL, | -- |
| Cond Setup | |
| ... | |
| } | |

| | |
|---|---|
| DRB-ToAddModList ::= | SEQUENCE (SIZE (1..maxDRB)) OF DRB-ToAddMod |
| DRB-ToAddMod ::= SEQUENCE { | |

| | | | |
|---|---|---|---|
| eps-BearerIdentity | INTEGER (0..15) | OPTIONAL, | -- Cond |
| DRB-Setup | | | |
| drb-Identity | DRB-Identity, | | |
| pdcp-Config | PDCP-Config | OPTIONAL, | -- Cond |
| PDCP | | | |
| rlc-Config | RLC-Config | OPTIONAL, | -- Cond |
| Setup | | | |
| logicalChannelIdentity | INTEGER (3..10) | OPTIONAL, | -- Cond |
| DRB-Setup | | | |
| logicalChannelConfig | LogicalChannelConfig | OPTIONAL, | -- Cond |
| Setup | | | |
| ... | | | |
| } | | | |

| | |
|---|---|
| DRB-ToReleaseList ::= | SEQUENCE (SIZE (1..maxDRB)) OF DRB-Identity |

| | |
|---|---|
| MeasSubframePatternPCell-r10 ::= | CHOICE { |
| release | NULL, |

| | |
|---|---|
| setup | MeasSubframePattern-r10 |
| } | |
| PHICH-REG-ConfigDedicated ::= | Sequence |

| | |
|---|---|
| PHICH REG MAP1 | INTEGER(1...7) |
| PHICH REG MAP2 | INTEGER(1...7) |
| -- ASN1STOP | |

TABLE 5
RadioResourceConfigDedicated with multiple PHICH_REG_MAPs field descriptions

logicalChannelConfig
For SRBs a choice is used to indicate whether the logical channel configuration is signalled explicitly or set to the
default logical channel configuration for SRB1 as specified in 9.2.1.1 or for SRB2 as specified in 9.2.1.2.
logicalChannelIdentity
The logical channel identity for both UL and DL.
mac-MainConfig
Although the ASN.1 includes a choice that is used to indicate whether the mac-MainConfig is signalled explicitly or set
to the default MAC main configuration as specified in 9.2.2, EUTRAN does not apply “defaultValue”.
measSubframePatternPCell
Time domain measurement resource restriction pattern for the PCell measurements (RSRP, RSRQ and the radio link
monitoring).
physicalConfigDedicated
The default dedicated physical configuration is specified in 9.2.4.
rlc-Config
For SRBs a choice is used to indicate whether the RLC configuration is signalled explicitly or set to the values defined
in the default RLC configuration for SRB1 in 9.2.1.1 or for SRB2 in 9.2.1.2. RLC AM is the only applicable RLC mode
for SRB1 and SRB2. E-UTRAN does not reconfigure the RLC mode of DRBs except when a full configuration option is
used, and may reconfigure the UM RLC SN field size only upon handover within E-UTRA or upon the first
reconfiguration after RRC connection re-establishment.
sps-Config
The default SPS configuration is specified in 9.2.3.
srb-Identity
Value 1 is applicable for SRB1 only.
Value 2 is applicable for SRB2 only.
PHICH_REG_MAP1
001 to 111; A ‘1’ will indicate presence of PHICH. The position of each bit corresponds to the REG number used for
sending PHICH. The PHICH group and PHICH seq number are derived from the UL grant.
PHICH_REG_MAP2
001 to 111; A ‘1’ will indicate presence of PHICH. The position of each bit corresponds to the REG number used for
sending PHICH. The PHICH group and PHICH seq number are derived from the UL grant, which different but related
to PHICH group and sequence number specified for PHICH REG MAP.

Alternatively, l and m can be defined as part of the RRC message (UE specific) or as part of the system information broadcast (SIB) message (cell specific). For example, if l=0; m=1 and PHICH_REG_MAP1=‘101’ and PHICH_REG_MAP2=‘011’, the UE will decode the REGs 1 and 3 on PHICH group, g₁ using the PHICH orthogonal sequence number n₁ and REGs 2 and 3 on the same PHICH group but using the PHICH orthogonal sequence number n₁+1. Similarly, if l=1; m=0 and PHICH_REG_MAP1=‘101’ and PHICH_REG_MAP2=‘011’, the UE will decode the REGs 1 and 3 on PHICH group, g₁ using the PHICH orthogonal sequence number n₁ and REGs 2 and 3 on PHICH group g₂ using the same PHICH orthogonal sequence number n₁. This method can be extended further to include more than two PHICH_REG_MAPs.

In some implementations, instead of sending a dedicated RRC messages such as a dedicated RRCConnectionReconfiguration message to a UE, the REG bit map can also be sent as part of the UL resource grant, i.e., as part of PDCCH. In this case, the PHICH REG assignment can be changed for every grant. The number of bits within the downlink control information (DCI) format 0 or format 4 may increase by 3 bits when PHICH is sent using less than 4 REGs or 6 bits otherwise. Table 6 provides an example DCI format 0 to support the flexible allocation of REGs for PHICH transmission. DCI format 0 is used for the scheduling of physical uplink shared channel (PUSCH) in an uplink cell. Similar field of PHICH_REGs can be applied to DCI format 4. In some implementations, the REG bit map can also be sent as a MAC control element.

TABLE 6
DCI Format 0

Carrier indicator - 0 or 3 bits.
Flag for format0/format1A differentiation - 1 bit, where value 0 indicates format 0 and value 1
indicates format 1A
Frequency hopping flag - 1 bit. This field is used as the MSB of the corresponding resource
allocation field for resource allocation type 1.
Resource block assignment and hopping resource allocation - ┌log₂ (N_{RB}^{UL} (N_{RB}^{UL} + 1)/2)┐ bits
Modulation and coding scheme and redundancy version - 5 bits
New data indicator - 1 bit
TPC command for scheduled PUSCH - 2 bits
Cyclic shift for DM RS and OCC index - 3 bits
UL index - 2 bits (this field is present only for TDD operation with uplink-downlink
configuration 0)
Downlink Assignment Index (DAI) - 2 bits (this field is present only for TDD operation with
uplink-downlink configurations 1-6)
CSI request - 1 or 2 bits. The 2-bit field only applies to UEs that are configured with more than
one DL cell and when the corresponding DCI format is mapped onto the UE specific search space
SRS request - 0 or 1 bit This field can only be present in DCI formats scheduling PUSCH which
are mapped onto the UE specific search space given by the C-RNTI.
Resource allocation type - 1 bit This field is only present if N_{RB}^{UL} < N_{RB}^{DL}.
PHICH REGs - 3 bits. The interpretation of this field is provided below.
PHICH_REGs
001 to 111; A ‘1’ will indicate presence of PHICH. The position of each bit corresponds to the REG
number used for sending PHICH.

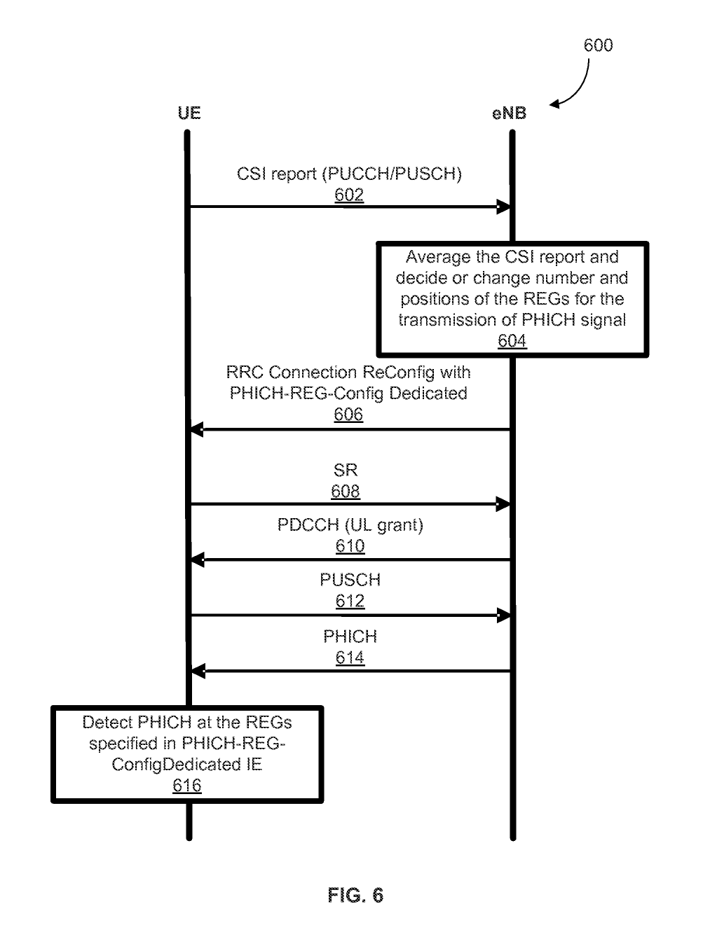

FIG. 6 illustrates a flow diagram of an example method for enabling code rate adaptation of PHICH signals by transmitting the REG information in a RRC message. As shown in FIG. 6, the UE 102a may send a channel state information (CSI) report to the eNB 112a via a physical uplink control channel (PUCCH) or a physical uplink shared channel (PUSCH) at 602. The CSI report may include an indicator of the signal reception quality at the UE, for example, the signal reception quality of a physical downlink shared channel (PDSCH) at the UE. In some implementations, the CSI report may include an indicator of the signal reception quality of the PHICH. For example, UE can report an average post detected SINR value observed during the PHICH detection (or other representation of PHICH detection error rate) to the eNB. This would result a better prediction of the PHICH reception quality at the eNB than from the PDSCH CSI. Furthermore, the UE can report two different SINR values, which correspond to detection of a NACK and an ACK respectively. A separate SINR report for ACK and NACK may further improve the prediction accuracy of the PHICH reception quality at the eNB.

After receiving the CSI report, the eNB may average the received CSI report with prior received CSI reports from the UE to obtain an accurate estimate of the PHICH channel condition, and then decide or change number and positions of the REGs for the transmission of PHICH signals at 604. For example, this could be done by a window-based averaging scheme. In some implementations, the averaging could be done on the UE side and the UE may report the averaged CSI report to the eNB. Averaging CSI reports may improve estimation of the PHICH channel condition. Subsequently, the eNB may transmit the dedicated RRCConnectionReconfiguration message to the UE at 606, including the REG information of the PHICH signal. The REG information may be contained in the PHICH-REG-ConfigDedicated information element, listed in Table 2 and Table 4. Note that other RRC messages could also be used.

The UE may transmit a scheduling request (SR) to request uplink resources for transmitting uplink packets at 608. The eNB may then transmit an uplink grant to the UE via DCI format 0 or DCI format 4 over the PDCCH at 610. After receiving the uplink grant, the UE may transmit the uplink packet at the granted uplink resources on PUSCH at 612. The eNB may then send the PHICH signal to the UE at 614, indicating a positive or negative acknowledgement of the uplink packet to the UE, on the REGs allocated to the PHICH signal. Since the information regarding the REGs used for the transmission of PHICH signal is specified in the previously transmitted RRC message (606), the UE is able to detect the PHICH signal at the REGs specified in PHICH-REG-ConfigDedicated information element at 616. Accordingly, the adaptive code rate of the PHICH signal is supported by increasing or reducing the number of REGs used for the transmission of PHICH signal.

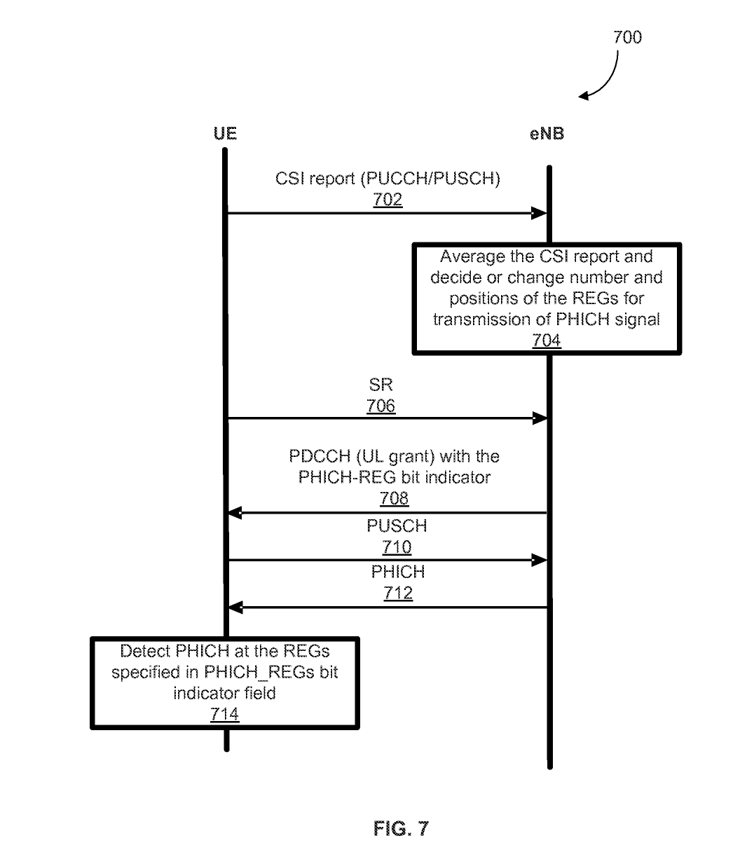

FIG. 7 illustrates a flow diagram of another example method for enabling code rate adaptation of PHICH signals by transmitting the REG information in an uplink grant message. As shown in FIG. 7, the UE 102a may send a CSI report to the eNB 112a via a physical uplink control channel (PUCCH) or a physical uplink shared channel (PUSCH) at 702. The CSI report may include an indicator of the signal reception quality of a physical downlink shared channel (PDSCH) at the UE. In some implementations, the CSI report may include an indicator of the signal reception quality of the PHICH.

After receiving the CSI report, the eNB may average the received CSI report with prior received CSI reports from the UE to obtain an accurate estimate of the PHICH channel condition, and then decide or change number and positions of the REGs for the transmission of PHICH signals at 704. For example, this could be done by a window-based averaging scheme. In some implementations, the averaging could be done on the UE side and the UE may report the averaged CSI report to the eNB. The UE may transmit a scheduling request (SR) to request uplink resources for transmitting uplink packets at 706. The eNB may then transmit an uplink grant with the PHICH_REGs bit indicator to the UE via PDCCH at 708. The uplink grant with the PHICH_REGs bit indicator may be transmitted using DCI format 0 or DCI format 4. The PHICH_REGs bit indicator indicates the REGs used to transmit the PHICH signal, as shown in Table 6. After receiving the uplink grant, the UE may transmit the uplink packet at the granted uplink resources on PUSCH at 710. The eNB may then send the PHICH signal to the UE at 712, indicating a positive or negative acknowledgement of the uplink packet to the UE, on the REGs allocated to the PHICH signal. Since the information regarding the REGs used for the transmission of PHICH signal is specified in the previously transmitted uplink grant (708), e.g., DCI format 0 or DCI format 4, the UE is able to detect the PHICH signal at the REGs specified in PHICH_REGs bit indicator at 714. Accordingly, the adaptive code rate of the PHICH signal is supported by increasing or reducing the number of REGs used for the transmission of PHICH signal.

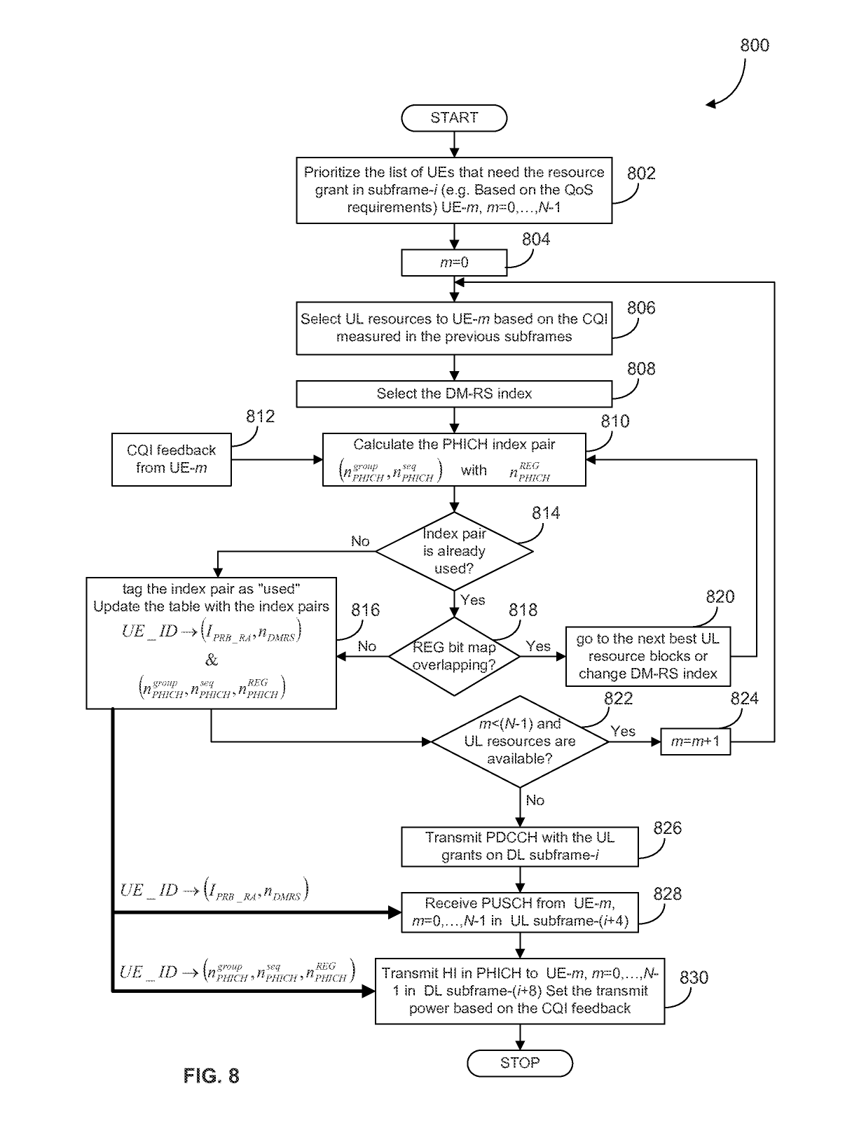

FIG. 8 illustrates a flow diagram of an example method for uplink resource grant procedure at the eNB to support PHICH signals with adaptive coding rate. As shown in FIG. 8, the eNB first prioritize the list of UEs that need uplink resources in subframe i at 802. The priority may depend on the user's quality of service (QoS) requirements. UE-0 is the UE having the highest priority, UE-1 is the UE having the second highest priority, and so on. The eNB may first select the UE with highest priority (i.e., UE-0) for resource allocation at 804. Next, the eNB may select uplink resources for that specific UE based on the channel quality information (CQI) measured in the previous subframes at 806 and select the demodulation reference signal (DM-RS) index for that UE accordingly at 808. Once the uplink resources and the DM-RS index for the UE are selected, the eNB calculates the PHICH index pair (n_{PHICH}^{group}, n_{PHICH}^{seq}) and decides the REGs suitable for the PHICH transmission represented by REG bit map n_{PHICH}^{REG} at 810. The REG bit map determines the number of REGs for the PHICH transmission and correspondingly the code rate for the PHICH transmission. The PHICH index pair and the REGs for PHICH transmission may be selected adaptively based on CQI feedback from the UE at 812. The CQI feedback may include an indicator of the signal reception quality of the PHICH or PDSCH.

The eNB may determine whether the PHICH index pair (n_{PHICH}^{group}, n_{PHICH}^{seq}) is already used for other UEs at 814. If the PHICH index pair is not already used, the eNB may determine that the PHICH index pair will be used for the UE. Accordingly, the eNB may tag the index pair as “used” and update the uplink resource table for the UEs at 816. The uplink resource table may include the identification (ID) of the UE, the allocated physical resource blocks I_{PRB}_{_{—}}_{RA} and DM-RS index n_{DMRS} for the UE, the PHICH index pair (n_{PHICH}^{group}, n_{PHICH}^{seq}) of the UE, and the REG bit map for the PHICH transmission n_{PHICH}^{REG}. The PHICH resource is identified by the index pair {n_{PHICH}^{group}, n_{PHICH}^{seq}}, where n_{PHICH}^{group} and n_{PHICH}^{seq} may be implicitly indicated to the UE by the allocated PUSCH physical resource blocks I_{PRB}_{_{—}}_{RA} and DM-RS index n_{DMRS}. If the PHICH index pair is already used for other UEs, the eNB may check whether the REG bit map overlaps with other UEs at 818. If the REG bit map for the UE does not overlap with other UEs, the eNB may determine that the PHICH index pair and the REG bit map will be used for the UE. Accordingly, the eNB may tag the index pair as “used” and update the uplink resource table for the UEs at 816. If the REG bit map overlaps with other UEs at 818, the eNB may select the next best uplink (UL) resource blocks or change the DM-RS index for the UE at 820, and then repeat the steps 810-818.

After updating the uplink resource table at 816, the eNB may check whether additional uplink resources are available for other UEs at 822. If additional resources are available and there are more UEs requesting for uplink grants at subframe i, the eNB may select the next UE on the priority list for uplink resource allocation at 824, and then repeat the steps 810-822.

If the eNB decides that no additional uplink resources are available or no more UEs need to be allocated for uplink resources at subframe i at 822, the eNB may transmit the PDCCH with uplink grants on downlink (DL) subframe i at 826. Subsequently, the eNB may receive PUSCH from a number of UEs in uplink subframe (i+4) at 828. The PUSCH transmitted from the UEs can be detected at the uplink resources listed in the uplink resource table corresponding to identification of each UE, e.g., based on the physical resource blocks I_{PRB}_{_{—}}_{RA} and DM-RS index n_{DMRS} for each UE. After receiving PUSCH from the UEs at 828, the eNB may transmit HI in PHICH to those UEs in downlink subframe (i+8) at 830. The PHICH resources are determined from the PHICH index pair (n_{PHICH}^{group}, n_{PHICH}^{seq}) and the REG bit map n_{PHICH}^{REG} for each UE. The transmit power of the PHICH signal may be based on the received CQI feedback at 812. As illustrated in FIG. 8, adaptive code rate of PHICH signals can be achieved by selecting appropriate REG bit map n_{PHICH}^{REG} for each UE, taking account of the PHICH channel conditions of the UEs.

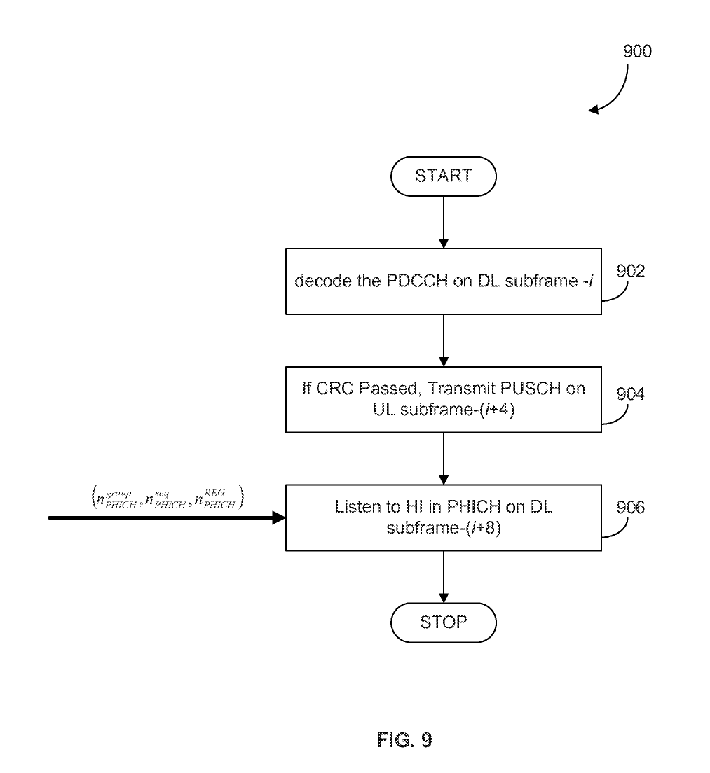

FIG. 9 illustrates a flow diagram of an example method for receiving PHICH signals with code rate adaptation performed by a user equipment. As shown in FIG. 9, the UE first decodes the PDCCH on downlink subframe i at 902. In some implementations, the UE may blindly decode the PDCCH without knowing the allocated PDCCH resources. If the cyclic redundancy check (CRC) is passed and the UE receives an uplink grant at downlink subframe i, the UE transmits a PUSCH on uplink subframe (i+4) at 904. Subsequent to the uplink transmission at 904, the UE listens to the HI in PHICH on downlink subframe (i+8) at 906. Specifically, the UE uses the PHICH index pair (n_{PHICH}^{group}, n_{PHICH}^{seq}) and the REG bit map n_{PHICH}^{REG} for the detection of PHICH signals. As the REG bit map n_{PHICH}^{REG} is adaptively chosen by the eNB and it is signaled to the UE prior to the PHICH transmission (either via the RRC messages, or the uplink grant DCI format 0 or DCI format 4, or the MAC control element), the UE may detect the PHICH signal with adaptive code rate successfully at downlink subframe (i+8). In some implementations, the REG bit map information may be transmitted to the UE in a RRCConnectionReconfiguration message or in an uplink grant message or in a MAC control element. After decoding the HI, the UE may retransmit the uplink packet if the HI is negative, which means that the PUSCH transmitted at 904 is not successfully at the eNB.

As described above, one of the benefits of the adaptive code rate control of PHICH is that the PHICH resources may be utilized efficiently depending on the channel conditions and thereby improving the PHICH capacity. Moreover, the adaptive rate control of PHICH enhances the PHICH coverage by allowing more REGs to be used for UEs at cell edge. In addition, it is not required to allocate extra control region resources to PHICH with the adaptive code rate, which greatly simplifies the system design and implementation.

The systems and methods described above may be implemented by any hardware, software or a combination of hardware and software having the above described functions. The software code, either in its entirety or a part thereof, may be stored in a computer readable memory.

While several implementations have been provided in the present disclosure, it should be understood that the disclosed systems and methods may be implemented in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various implementations as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

While the above detailed description has shown, described, and pointed out the fundamental novel features of the disclosure as applied to various implementations, it will be understood that various omissions and substitutions and changes in the form and details of the system illustrated may be made by those skilled in the art, without departing from the intent of the disclosure.

What is claimed is:

1. A method for wireless communication, comprising:
receiving a message including information regarding one or more Resource Element Groups (REGs) used to transmit a Physical Hybrid Automatic Repeat Request (HARQ) Indicator Channel (PHICH) signal; and
detecting the PHICH signal.

2. The method of claim 1, wherein the PHICH signal is detected using a repetition code.

3. The method of claim 1, wherein the message is a Radio Resource Control (RRC) message.

4. The method of claim 1, wherein the information is represented by one or more bit maps.

5. The method of claim 1, wherein the message is an uplink resource grant message.

6. The method of claim 5, wherein the uplink resource grant message is received using at least one of Downlink Control Information (DCI) format 0 or DCI format 4.

7. The method of claim 1, further comprising transmitting Channel State Information (CSI) prior to receiving the message including information regarding the one or more REGs.

8. The method of claim 7, wherein the CSI is determined based on measurement of a Physical Downlink Shared Channel (PDSCH).

9. The method of claim 7, wherein the CSI is determined based on measurement of a PHICH.

10. The method of claim 1, further comprising transmitting an uplink packet prior to detecting the PHICH signal.

11. The method of claim 10, further comprising transmitting a scheduling request prior to receiving the message including information regarding the one or more REGs.

12. A user equipment configured to:
receive a message including information regarding one or more Resource Element Groups (REGs) used to transmit a Physical Hybrid Automatic Repeat Request (HARQ) Indicator Channel (PHICH) signal; and
detect the PHICH signal.

13. The user equipment of claim 12, wherein the PHICH signal is detected using a repetition code.

14. The user equipment of claim 12, wherein the message is a Radio Resource Control (RRC) message.

15. The user equipment of claim 12, wherein the information is represented by one or more bit maps.

16. The user equipment of claim 12, wherein the message is an uplink resource grant message.

17. The user equipment of claim 16, wherein the uplink resource grant message is received using at least one of Downlink Control Information (DCI) format 0 or DCI format 4.

18. The user equipment of claim 12, further configured to transmit Channel State Information (CSI) prior to receiving the message including information regarding the one or more REGs.

19. The user equipment of claim 18, wherein the CSI is determined based on measurement of a Physical Downlink Shared Channel (PDSCH).

20. The user equipment of claim 18, wherein the CSI is determined based on measurement of a PHICH.

21. The user equipment of claim 12, further configured to transmit an uplink packet prior to detecting the PHICH signal.

22. The user equipment of claim 21, further configured to transmit a scheduling request prior to receiving the message including information regarding the one or more REGs.
